(19) United States
(12) Patent Application Publication
(10) Pub. No.: US 2003/0184075 A1
(43) Pub. Date: Oct. 2, 2003

(54) Frame member having overlapping reinforcement sections

(76) Inventors: Richard B. Freeman, Oxford, MI (US); Donald R. Allen, Rochester Hills, MI (US)

Correspondence Address: HARNESS, DICKEY & PIERCE, P.L.C., P.O. BOX 828, BLOOMFIELD HILLS, MI, 48303, US

(21) Appl. No.: 10/107,225

(22) Filed: Mar. 27, 2002

(51) Int. Cl. B62D 21/00

(52) U.S. Cl. 280/797

(57) ABSTRACT

A vehicle structural frame having a plurality of tubular elements is formed from first and second generally C-shaped elongated members. Each member has a first flange and a second flange separated by a web. The flanges of the first and second members overlap each other to form two pairs of overlapped flanges. Each pair of overlapped flanges of both the first and second pair of overlapped flanges are joined by at least two longitudinal welds. The longitudinal welds join each pair of flanges to form each element of the plurality of tubular elements of a vehicle structural frame. Lengthening the flange overlap and providing two or more longitudinal welds increases frame bending stiffness allowing reduced member thickness and weight.

### FIELD OF THE INVENTION

The present invention relates generally to frame members, and more specifically to an apparatus and a method for forming a vehicle frame to provide a reduced weight frame member.

### BACKGROUND OF THE INVENTION

Structural frames, particularly structural frames for automotive or vehicle use have at least portions of the frame formed in tubular shapes. The tubular shapes are configured in straight, bent and reducing sections and provided with additional attachments to suit the support requirements of the vehicle. The weight of a vehicle frame is critically analyzed because the fuel economy of a vehicle depends in part on its overall weight and the frame is a significant component of vehicle weight. Optimizing the weight of a vehicle frame involves selection of the wall thickness, material properties, and shape to provide necessary frame strength and stiffness.

In order to provide suitable bending and torsional stiffness and ease of fabrication for a vehicle frame, a rectangular or box-shaped structure is often used. This structure is frequently assembled by providing two C-shaped members which each include flanges separated by a web section. The flanges of the C-shaped members are either abutted and welded longitudinally or the flanges are slightly overlapped and a single longitudinal attachment weld such as a lap (i.e., fillet weld) weld joins each flange pair of the frame portion. In order to increase the bending stiffness of a structure of this design, the flange thickness of each C-shaped member flange is increased. Increasing the flange stiffness by increasing flange thickness detrimentally increases the web thickness. Increasing the web thickness does not significantly increase the bending stiffness of the structure, therefore detrimentally adding weight for little structural benefit. The overall weight of the vehicle frame is therefore increased by this approach to increasing the structure's bending stiffness.

Bending stiffness can be increased without increasing the web thickness by providing longer flanges and increasing the percentage of overlap of the flanges of each of the C-shaped members. A conventional vehicle frame constructed by overlapping the C-shaped member flanges normally provides about 25% overlap of the straight length of each flange. Partially increasing the percentage of overlap increases the stiffness of the structure, however, the full benefit of increasing the overlap percentage is not achieved if only a single longitudinal lap weld joins the pairs of flange members. The single lap weld joint is made on the outward facing joint of each pair of overlapped flanges. A distal end of the inside facing (i.e., overlapped) flange of each pair of overlapped flanges is not structurally connected to its outward facing counterpart. The doubled thickness of the overlapped flanges is therefore not accounted for in the bending stiffness of the member pair.

The geometry of various portions of the frame must often be changed in order to adapt to the configuration of the vehicle. Such changes are required in the exemplary areas of the engine and tires of the vehicle. The sections where the frame includes bends and additional joints are desirably formed prior to the longitudinal welding of the C-shaped members. The fit-up of the bent members creates alignment difficulties for subsequent welding of the C-shaped sections. It often becomes increasingly difficult to align and weld the C-shaped member flanges as the flange overlap percentage increases for a frame having multiple bends or changing geometry.

As noted above, material selection is important to achieve structural stiffness at minimum weight. Materials commonly employed for vehicle frames include steels such as low carbon steel and high-strength/low alloy steels. Unfortunately, common frame materials are subject to corrosion. Corrosion is controllable by addition of coatings but coating material further increases vehicle frame weight and cost. Stainless steels and lighter weight corrosion resistant materials such as aluminum are desirable materials to substitute for the commonly used steel materials to reduce weight and corrosion potential. Stainless steels are more costly, however, and a need exists to decrease the volume of stainless steel used while retaining frame stiffness.

### SUMMARY OF THE INVENTION

The above drawbacks and limitations are overcome, and the benefits identified herein are provided by a structural component of the present invention. In one aspect of the present invention a structural component comprising a first and a second generally C-shaped elongated member is provided. Each member has flanges separated by a web. The flanges of the first and second members overlap each other to form two pairs of overlapped flanges. Each of the pairs of overlapped flanges are joined by at least two longitudinal attachments joints. The longitudinal attachment joints join the flanges of the first and second members and, together with the web of each member, form a structural component providing reduced material cross section and reduced weight.

In a further aspect of the invention a vehicle structural frame is provided comprising a plurality of tubular elements. Each element is formed from first and second generally C-shaped elongated members. Each member has a first flange and a second flange separated by a web. The flanges of the first and second members overlap each other to form two pairs of overlapped flanges. Each pair of overlapped flanges of both the first and second pair of overlapped flanges are joined by at least two longitudinal joints. The vehicle structural frame has improved element bending stiffness allowing reduced member cross section and weight.

In still another aspect of the present invention a method of making a structural member is provided comprising the steps of stamping a pair of generally C-shaped elongated members, each member having a first flange and a second flange separated by a web; overlapping the flanges of the first and second members to form two pairs of overlapped flanges; and joining each pair of overlapped flanges by at least two longitudinal attachment joints to form a structural component having reduced material cost section and reduced weight.

Preferably, each flange of each C-shaped member is connected to each web by a radius member. Each radius member is connected to a flange body at a flange body first end. Each flange body has a central body disposed between the flange body first end and a flange distal end. Each of the flanges of each C-shaped member overlap the flanges of its counterpart C-shaped member. By almost completely overlapping each flange central body, the bending stiffness of the structural frame is improved.

In addition to fully overlapping the flanges of the C-shaped members at least two longitudinal joints are used to fully join the overlapped flanges. A distal end of an outside facing one of the overlapped flanges is longitudinally welded to the outside face adjacent the radius member of the inner facing flange of the pair of overlapped flanges. This joint is similar to the attachment joint used in conventional vehicle frames. An improvement to the conventional frame is provided by a second longitudinal joint joining an inside facing distal flange end to the inside face of the outside facing overlapped flange. The second joint increases bending stiffness of the overlapped members.

Conventional vehicle frames provide about 25% overlap of the flange members when two C-shaped members are used to construct a frame. According to the present invention, the percentage of overlap is increased to a range between over about 25% and up to a total of 100% overlap of each flange's length of each pair of overlapped flanges. As the percentage of overlapped flange length increases, the bending stiffness of the frame also increases. With 100% overlap of the flanges, a maximum potential bending stiffness is reached. Using a second weld joint to join the fully overlapped flanges provides maximum bending stiffness. Also, as the percentage of overlap of the flanges increases, the wall thickness of the C-shaped members can be decreased to reduce the total weight of the frame assembly. A maximum weight savings is achieved at 100% flange overlap when the second weld joint is also used.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view showing two C-shaped members prior to assembly;

FIG. 2 is a section view taken along Section I-I of FIG. 4 showing the C-shaped members of FIG. 1 in a conventional arrangement of C-shaped members;

FIG. 3 is a section view taken along Section II-II of FIG. 4, showing a fully overlapped and double welded configuration of C-shaped members of the present invention;

FIG. 4 is a perspective view of an exemplary vehicle structural frame;

FIG. 5 is a partial section view of FIG. 2 showing the details of a conventional single weld joining C-shaped members;

FIG. 6 is a partial section view of FIG. 3 detailing the fully overlapped flanges and the two attachment welds of the present invention;

FIG. 7 is a perspective view of an assembled member pair of an alternate embodiment of the present invention;

FIG. 8 is a perspective view showing only the laser portion of the laser/MIG full penetration welding process to identify a laser cutting depth prior to filler metal insertion into the weld joint; and

FIG. 9 is a perspective view of exemplary overlapped joints and a full penetration weld of the present invention showing both the laser and MIG torch used to make the weld.

### DETAILED DESCRIPTION OF THE PREFERRED EMBODIMENTS

The following description of the preferred embodiment(s) is merely exemplary in nature and is in no way intended to limit the invention, its application, or uses.

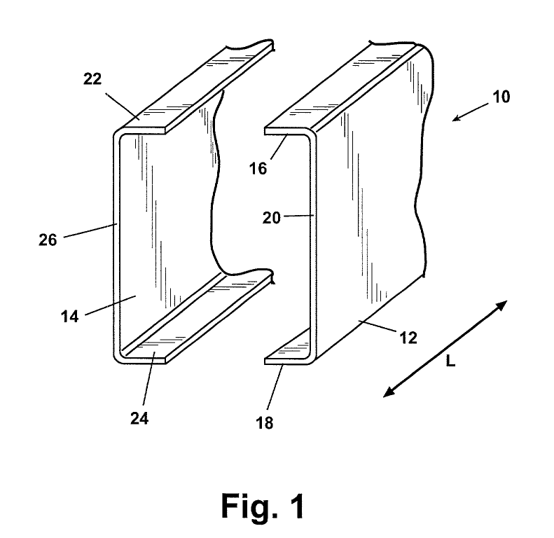

Referring to FIG. 1, two C-shaped elongated members are shown forming a member pair 10. The member pair 10 comprises a first C-shaped member 12 and a second C-shaped member 14. The first C-shaped member 12 further comprises a first flange 16, a second flange 18, and a first member web 20. The second C-shaped member 14 further comprises a first flange 22, a second flange 24, and a second member web 26. Each of the first and the second C-shaped members, 12 and 14 respectively, have a predetermined member length L. The first C-shaped member 12 and the second C-shaped member 14 are normally stamped to form the C-shape.

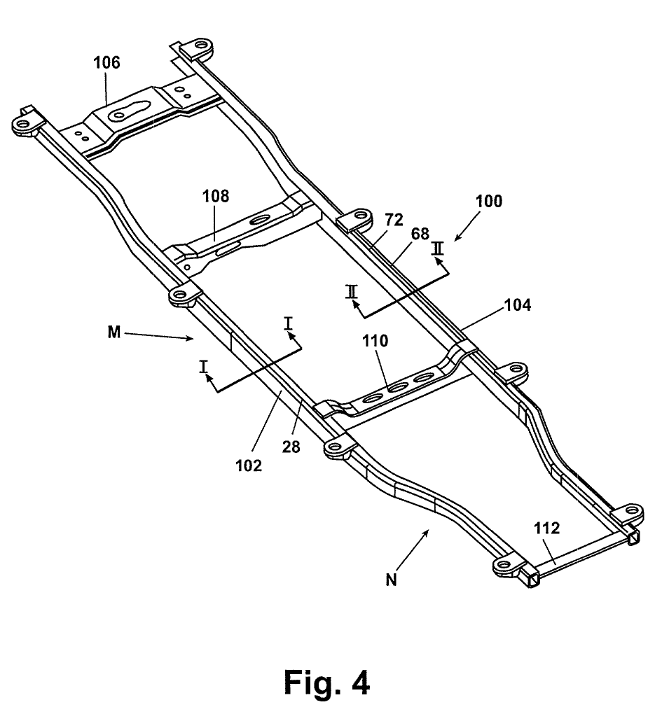

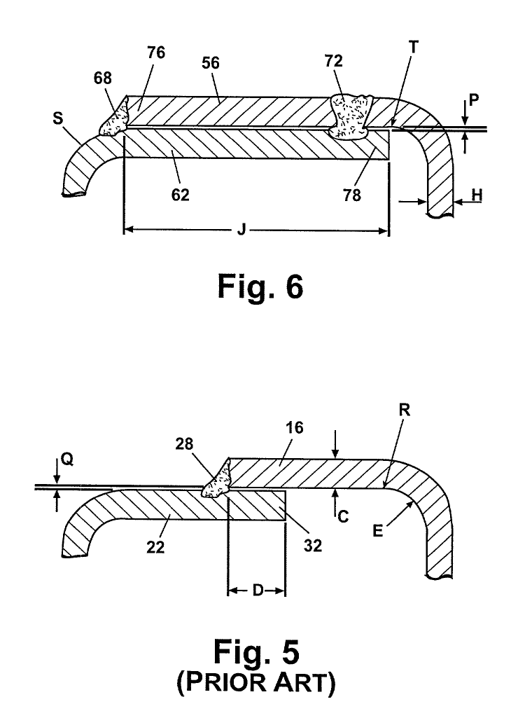

Referring now to FIG. 2, a section view of a conventional vehicle frame taken at section I-I of FIG. 4 is shown. To form the member pair 10, a portion of the first flange 16 of the first C-shaped member 12 and a portion of the first flange 22 of the second C-shaped member 14 are overlapped. At the same time, a portion of the second flange 18 of the first C-shaped member 12 and a portion of the second flange 24 of the second C-shaped member 14 are overlapped. The overlapped flanges of the first C-shaped member 12 and the second C-shaped member 14 are joined by an upper exterior weld 28 and a lower exterior weld 30. FIG. 6 provides a further detail of upper exterior weld 28. The lower exterior weld 30 (which is not shown in FIG. 6) is similar to the upper exterior weld 28.

When joined into a welded pair of members, the first C-shaped member 12 and the second C-shaped member 14 have a combined assembly width A. Each of the C-shaped members, 12 and 14 respectively, has a member height B and a full member thickness C. Each of the first and second C-shaped members, 12 and 14 respectively, are stamped having an inside radius E in two places.

The member pair 10 forms a portion of a structural member for a vehicle frame. Each overlapped flange pair has an overlap length D representing a percentage of each flange straight length. For a conventional frame, the percentage of flange overlap as overlap length D varies but is generally about 25% of the straight length of each of the flanges. The straight length of a flange is determined based on the flange length between the flange tangent point with the radius formed between each web and flange, and a distal end of each flange. Each flange pair is joined by a single exterior weld, i.e., the upper exterior weld 28 or the lower exterior weld 30 each extending about the entire member length L (shown in FIG. 1). Increasing the overlap length D provides some additional bending stiffness for the member pair 10. Full bending stiffness is not developed by increasing flange overlap, however, since each flange pair is joined by only the single exterior weld.

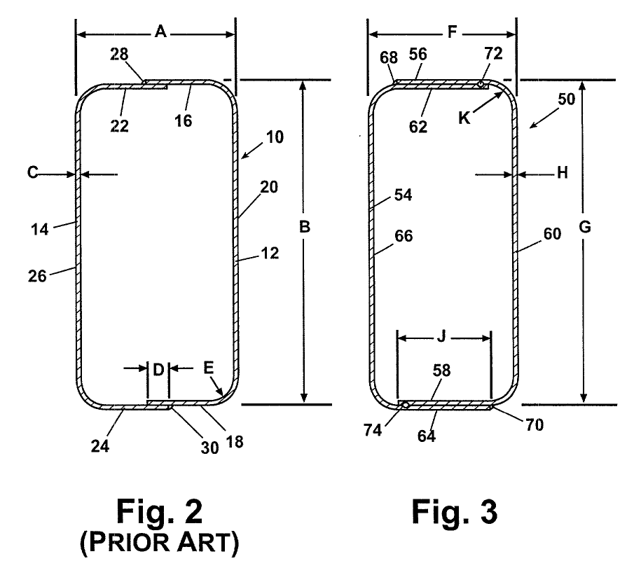

Referring now to FIG. 3, a member pair 50 of the present invention is shown. FIG. 3 is a cross section taken through Section II-II of FIG. 4. The member pair 50 comprises a first C-shaped member 52 and a second C-shaped member 54. The first C-shaped member 52 further comprises a first flange 56, a second flange 58, and a first member web 60. The second C-shaped member 54 further comprises a first flange 62, a second flange 64, and a second member web 66. Similar to the arrangement of FIG. 2 the member pair 50 has the outside facing portions of the flanges joined by an upper exterior weld 68 and a lower exterior weld 70 respectively. FIG. 3 differs from the section view of FIG. 2 by the increased flange overlap and the addition of a full penetration, longitudinal weld joining the distal interior flange of each pair of overlapped flanges. In addition to the upper exterior weld 68 and the lower exterior weld 70, the member pair 50 also provides an upper full penetration weld 72 and a lower full penetration weld 74. The upper full penetration weld 72 joins a distal end of the inside facing first flange 62 to the outside facing first flange 56. The lower full penetration weld 74 similarly joins a distal end of the inside facing second flange 58 to the outside facing second flange 64. The inside to outside facing arrangement of flanges shown in FIG. 3 is also reversible, i.e., having the first flange 56 overlapped by the first flange 62 and having the second flange 64 overlapped by the second flange 58.

The member pair 50 is shown having assembly width F, C-shaped member height G, reduced member thickness H, and extended overlap J. By providing an increased amount of overlap of the flanges, herein shown as extended overlap J, the member pair 50 of the present invention can be provided with the same outside perimeter dimensions as the conventional member pair 10 of FIG. 2. The assembly width F and the C-shaped member height G can also be dimensioned the same as the assembly width A and the C-shaped member height B of the member pair 10. Exemplary dimensions for both the assembly width A and the assembly width F are about 7.6 centimeters (cm). Exemplary dimensions for the C-shaped member height B and the C-shaped member height G are about 16.5 cm. By providing the extended overlap J, bending stiffness is increased allowing a reduced member thickness H for the member wall thicknesses of the member pair 50. The exemplary full member thickness C of the member pair 10 is about 3 millimeters (mm). By increasing flange overlap as the extended overlap J and adding the full penetration welds of the present invention, an exemplary member thickness H of 1.91 mm is achieved. Reducing the member thickness H from full member thickness C provides an overall weight reduction while retaining bending stiffness for the vehicle frame. By using both an exterior lap weld and a full penetration weld with steel material commonly used, the present invention member pair 50 provides the same bending stiffness as the conventional member pair 10, but with reduced member thickness H.

Referring to FIG. 4, a vehicle frame 100 is shown providing an exemplary arrangement of a motor vehicle frame having a general shape known in the art. Vehicle frame 100 comprises a first side rail 102, a second side rail 104, and a plurality of cross members. The plurality of cross members shown in FIG. 4 comprise a first cross member 106, a second cross member 108, a third cross member 110 and a fourth cross member 112. The number and locations of cross members are varied as known in the art to suit the desired arrangement of the vehicle frame 100. Section I-I is taken through a straight member length M of the vehicle frame 100 having a vehicle frame constructed as known in the art. FIG. 3 is taken along Section II-II of FIG. 4, showing a portion of a vehicle frame constructed per the present invention. Both FIGS. 2 and 3 show an exemplary rectangular shaped structural member portion of the vehicle frame 100.

A vehicle frame typically includes shaped member areas such as a shaped section N of vehicle frame 100. As shown in FIG. 4, the shaped section N shows a continuously changing cross section. The advantages of the present invention apply for changing cross sections as well as straight sections shown in FIG. 3. For example, an assembly width F (shown in FIG. 3) can increase in the shaped section N while the C-shaped member height G decreases. The shaped section N discloses at least one bend can also be incorporated in both the first C-shaped member and the second C-shaped member either prior to or following their assembly as a member pair.

Referring now to FIG. 5, a partial section view of FIG. 2 shows the two upper first C-shaped members of a conventional overlapped pair of flanges in greater detail. The first flange 16 of the first C-shaped member 12 and the first flange 22 of the second C-shaped member 14 of the member pair 10 are shown, joined by the single longitudinal weld joint, upper exterior weld 28. A portion (about 25%) of the straight length of the first flange 16 and a portion (about 25%) of the straight length of the first flange 22 are overlapped to form the overlap D as shown. With an overlap of about 25%, the distal end 32 of the first flange 22 does not approach the tangent point R of the first flange 16 inside radius E. The full member thickness C represents the wall thickness optimized for the partially overlapped flange design of FIG. 5. For a low carbon material, full member thickness C is about 0.30 mm. A gap Q is shown between the first flange 16 and the first flange 22 representing the maximum allowable gap appropriate for welding. Since the gap Q is similar to the gap P of FIG. 6, which is more fully described below, the gap Q will therefore not be further described herein.

Referring now to FIG. 6, a partial section view of FIG. 3 shows the two upper first C-shaped members of FIG. 3 in greater detail. The first flange 56 of the first C-shaped member 52 fully overlaps the first flange 62 of the second C-shaped member 54 in this exemplary embodiment of the present invention. The fully overlapped flanges are joined in at least two locations by the upper exterior weld 68 and the upper full penetration weld 72. The maximum bending stiffness is achieved for the member pair 50 when extended overlap J is maximized as shown in FIG. 6. A minimum wall thickness for the member thickness H is also achieved by maximizing the extended overlap J. An exemplary minimum wall thickness dimension for the member thickness H is about 1.91 mm for a low carbon steel, which is reduced from the full thickness of about 3.0 mm noted above for a 25% flange overlap.

As shown in FIG. 6, the first flange 56 is the outside facing flange of the member pair 50 and the first flange 62 is the inside facing flange of the member pair 50. In a preferred embodiment of the present invention, maximum flange overlap is provided by the upper exterior weld 68 joining an outside distal end 76 of the first flange 56 at an outside facing radial surface S of the first flange 62. Simultaneously, an inside distal end 78 of the first flange 62 meets the tangent point T of the inside radius K (shown in FIG. 3) of the first flange 56. A gap P between the first flange 56 and the first flange 62 represents the fit-up clearance between the first flange 56 to the first flange 62. The gap P results when either or both of the flanges “spring” during stamping or forming. The gap P should be controlled to ensure proper weld joint fit-up. A small dimension for the gap P is desirable to permit sliding fit-up of members for welding and will not detrimentally effect weld formation. An exemplary dimension of gap P known to be acceptable for welding is about 1½ mm. Larger dimensions for gap P can also result as material thickness or type changes.

According to the invention, maximizing the extended overlap J increases the bending stiffness of the member pair 50. Adding the upper full penetration weld 72 with full flange overlap maximizes the bending stiffness of the member pair 50. The upper full penetration weld 72 is preferably formed using a laser assisted manual inert gas (MIG) weld process, and will be discussed in greater detail in reference to FIG. 8. This laser/MIG process uses a laser to penetrate the first flange 56 thickness and a portion of the interior facing first flange 62 thickness. The first flange 56 and the first flange 62 are then joined using a weld filler material added by the MIG process to form the upper full penetration weld 72. The lower full penetration weld 74 of FIG. 3 is formed using the same laser/MIG welding process as the upper full penetration weld 72.

The tangent points R and T shown in FIGS. 5 and 6, respectfully, represent the tangential junction of the straight length of the flanges of each C-shaped member with the radius interconnecting the flange to the web of each C-shaped member. The percentage of overlap for the extended overlap J of FIG. 6 can be varied between the conventional value (i.e., about 25%) and 100% overlap of the flanges shown in FIG. 6. Providing less than 100% extension of the extended overlap J provides less than maximum bending stiffness for the member pair 50 and will therefore result in a greater than optimized member thickness H.

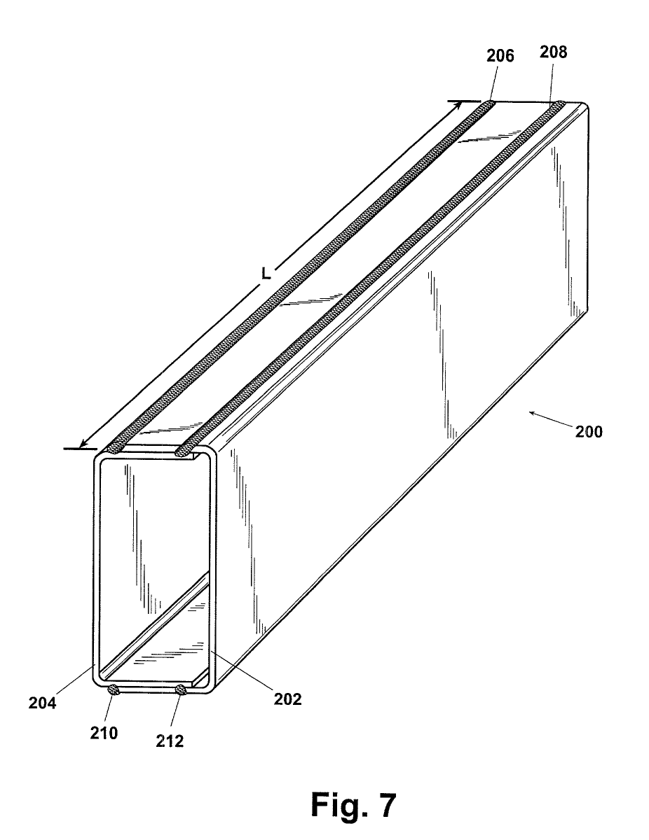

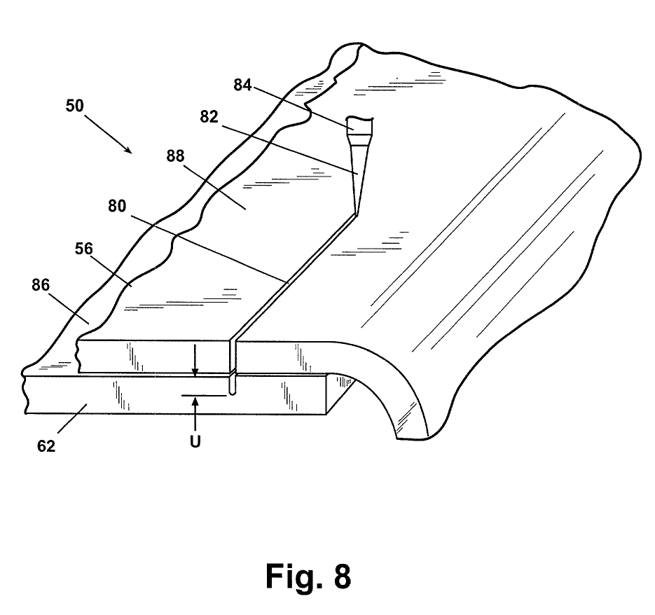

FIG. 7 shows an assembled member pair 200 of the present invention, providing an alternate embodiment of C-shaped members. An inside face of each flange of a first C-shaped member 202 fully overlaps an outside face of each flange of the second C-shaped member 204. In the alternate embodiment shown, the dimension G of FIG. 3 is reduced for the second C-shaped member 204 until the flanges of the second C-shaped member 204 nest within both flanges of the first C-shaped member 202. An opposite arrangement is also possible, having the flanges of the first C-shaped member 202 both overlapped within the flanges of the second C-shaped member 204. FIG. 7 also shows an upper exterior weld 206 (similar to the upper exterior weld 68) and an upper full penetration weld 208 (similar to the upper full penetration weld 72) for the full length L of assembled member pair 200. A lower exterior weld 210 and a lower full penetration weld 212 are also shown.

Referring now to FIG. 8, an exemplary overlapped pair of flange members of the present invention is shown with only the laser beam portion of a laser assisted MIG full penetration weld process shown. The overlapped pair of flange members comprises the member pair 50, having the first flange 56 overlapping the first flange 62. A slot 80 is cut by a laser beam 82 through the complete thickness of the first flange 56 (the outside facing flange) to a depth U measured from an outer flange face 86 of the first flange 62 (the inside facing flange). The depth U can vary as a percentage of material thickness. In an exemplary arrangement, it is desirable to provide the depth U to a range of about 25% to about 40% of the member thickness H to achieve sufficient weld joint strength. The angle of incidence for the laser beam 82 is about normal to a flange face 88 of the first flange 56.

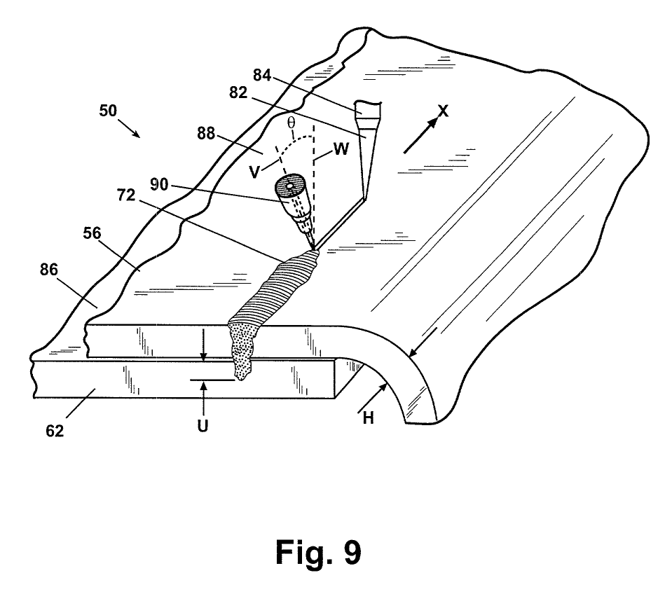

Referring to FIG. 9, a laser assisted MIG weld forming the upper full penetration weld 72 of the present invention is shown. FIG. 9 is similar to FIG. 8 and therefore only the differences will be further described herein. FIG. 9 shows the additional MIG portions of the full penetration weld process of the present invention. The upper full penetration weld 72 is formed by a MIG torch 90 providing an arc to vaporize metal adjacent to the slot 80 cut by the laser beam 82. Filler metal is then added through or adjacent to the MIG torch 90 to fill the slot 80 for the full depth U of the first flange 62 and throughout the member thickness H of the first flange 56. The upper full penetration weld 72 will normally “crown” slightly above a flange face 88 to preclude weld undercut and provide full weld depth. The MIG torch 90 is shown disposed at an angle α along the travel direction of both the laser source 84 and the MIG torch 90, indicated by arrow X. The angle θ is measured between a vertical axis W and a centerline V of the MIG torch 90. The angle θ will normally vary between about 20 degrees to about 45 degrees from the vertical axis W for steel materials, and will be about 75 degrees from the vertical axis W for aluminum material. The MIG torch 90 normally follows behind the laser source 84.

Material for the C-shaped members normally comprises steel materials. Steel materials commonly used for vehicle frames include low carbon steel and high strength/low alloy steel. Stainless steels are an alternative steel material. Aluminum or similar lighter weight materials may also be substituted for the C-shaped members. Aluminum material provides a further weight decrease for the member pairs. Controlling the percentage of extension for the extended overlap J while retaining member thickness H allows a material such as aluminum to be substituted for a low carbon steel while retaining member pair bending stiffness. For higher strength materials, bending stiffness is retained while minimizing member thickness H, allowing reduction of the member pair 50 weight for a given material.

The present invention provides several benefits. As the percentage of flange overlap for a vehicle frame formed with C-shaped members increases, the bending stiffness for the frame increases. By adding a weld joining internally facing flanges, a maximum bending stiffness of the vehicle frame can be achieved, allowing reduced wall thickness and reduced weight for the vehicle frame. A minimal wall thickness with a resulting decreased vehicle frame weight is achieved by maximizing flange overlap. For a given cross section of a vehicle frame, the bending stiffness can be retained while reducing the wall thickness of the C-shaped members by using a structural component of the present invention. In an alternate aspect of the invention, the bending stiffness of a given vehicle frame can be increased by retaining rather than decreasing the member wall thickness, using a structural component of the present invention. The structural component of the present invention also permits the substitution of a lighter weight material without sacrificing bending stiffness for a given frame size.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A structural component comprising:
first and second generally C-shaped elongated members, each member having flanges separated by a web;
the flanges of the first and second members overlapping each other to form two pairs of overlapped flanges; and
each of the pairs of overlapped flanges being joined by at least two longitudinal attachment joints;
wherein the longitudinal attachment joints join the flanges of the first and second members and, together with the web of each member, form a structural component with reduced material cross section and reduced weight.

2. The structural component of claim 1, further comprising:
the at least two longitudinal attachment joints are at a first location and a second location;
each first location being an exterior junction between the flanges of each of the pairs of overlapped flanges; and
each second location being an interior junction between flanges of each of the pairs of overlapped flanges.

3. The structural component of claim 2, further comprising:
each flange of each member has a radius end joined to the web and a flange body disposed between the radius end and a flange distal end; and
each flange of each of the pairs of overlapped flanges being overlapped over at least a portion of the flange body between the radius end and the distal end.

4. The structural component of claim 3, further comprising:
each pair of overlapped flanges having an outside facing flange and an inside facing flange;
each exterior junction having the distal end of the outside facing flange forming a contact joint at about the radius end of the inside facing flange; and
each interior junction having the distal end of the inside facing flange forming a contact joint at about the radius end of the outside facing flange.

5. The structural component of claim 4, wherein each flange of each of the pairs of overlapped flanges is overlapped over substantially the entire length of the flange body between the radius end and the distal end.

6. The structural component of claim 4, wherein the at least two longitudinal connecting means further comprise welded joints.

7. The structural component of claim 6, wherein the welded joints further comprise laser assisted welds.

8. The structural component of claim 6, further comprising:
each contact joint of each exterior junction is connectably joined by a fillet weld; and
each contact joint of each interior junction being connectably joined by a laser assisted manual inert gas (MIG) weld.

9. The structural component of claim 1, wherein a material of said member comprises a steel material.

10. The structural component of claim 1, wherein a material of said member comprises an aluminum material.

11. The structural component of claim 3, further comprising:
each member having a first flange and a second flange;
a first pair of overlapped flanges being formed by overlapping the distal end of each first flange of the first and second members until the distal end of the first flange of the first member approaches the radius end of the first flange of the second member; and
a second pair of overlapped flanges being formed by overlapping the distal end of each second flange of the first and second members until the distal end of the second flange of the first member approaches the radius end of the second flange of the second member.

12. A vehicle structural frame comprising:
a plurality of tubular elements each formed from first and second generally C-shaped elongated members;
each member having a first flange and a second flange separated by a web;
the flanges of the first and second members overlapping each other to form two pairs of overlapped flanges; and
each pair of overlapped flanges of both the first and second pair of overlapped flanges being joined by at least two longitudinal joints;
wherein the at least two longitudinal joints join each pair of flanges to form each element of the plurality of tubular elements of a vehicle structural frame having improved element bending stiffness allowing reduced member cross section and weight.

13. The vehicle structural frame of claim 12, further comprising:
a first pair of overlapped flanges including the first flange of the first member and the first flange of the second member; and
a second pair of overlapped flanges including the second flange of the first member and the second flange of the second member.

14. The vehicle structural frame of claim 13, further comprising:
each flange is connected to each web by a radius member;
each radius member is connected to a flange body at a flange body first end; and
each flange body further includes a central body disposed between the flange body first end and a flange distal end.

15. The vehicle structural frame of claim 14, wherein each first and second pair of overlapped flanges is formed by completely overlapping each flange central body of each pair of flanges.

16. The vehicle structural frame of claim 14, further comprising:
each tubular element has at least one cross sectional geometry; and
the cross sectional geometry being variable along a longitudinal length of each tubular element.

17. The vehicle structural frame of claim 13, further comprising:
a first spacing between the flanges of the first member;
a second spacing between the flanges of the second member; and
the first spacing and the second spacing being about equal such that the first flange of the first member is arranged above the first flange of the second member and the second flange of the first member is arranged above the second flange of the second member.

18. The vehicle structural frame of claim 13, further comprising:
a first spacing between the flanges of the first member;
a second spacing between the flanges of the second member; and
said second spacing being smaller than said first spacing such that the flanges of the second member both nest between the flanges of the first member.

19. The vehicle structural frame of claim 16, further comprising:
each member has a thickness; and
the thickness being variable over a range of thicknesses.

20. The vehicle structural frame of 19, wherein the range of thicknesses is preselected to vary between about 1.91 millimeters and about 3.0 millimeters.

21. A method of making a structural member comprising the steps of:
stamping a pair of generally C-shaped elongated members, each member having a first flange and a second flange separated by a web;
overlapping the flanges of the first and second members to form two pairs of overlapped flanges, each pair of overlapped flanges having an outside facing flange and an inside facing flange; and
joining each pair of overlapped flanges by at least two longitudinal attachment joints to form a structural component having reduced material cross section and reduced weight.

22. The method of claim 21, further comprising the step of welding at least two longitudinal weld joints to form the at least two longitudinal attachment joints for each pair of overlapped flanges.

23. The method of claim 22, further comprising the steps of:
fully overlapping each pair of overlapped flanges to maximize a bending stiffness of the structural member; and
selecting a material having a reduced wall thickness for each member to reduce a weight of said structural member.

24. The method of claim 21, further comprising the step of forming said at least two longitudinal attachment joints as both an overlap weld joint and a full penetration weld joint.

25. The method of claim 24, further comprising the steps of:
engaging a welding torch at a junction of outside facing surfaces of each said pair of overlapped flanges;
forming said overlap weld joint using said welding torch and a filler material;
providing a laser assisted MIG welding torch having a laser beam to vaporize said overlapped flanges and a MIG torch to join said vaporized overlapped flanges;
aligning said laser assisted MIG welding torch at each said pair of overlapped flanges at a location parallel with each said overlap weld joint;
vaporizing a first longitudinal slot through the outside facing flange of each said pair of overlapped flanges;
simultaneously partially vaporizing a second longitudinal slot in the inside facing flange of each said pair of overlapped flanges; and
adding a filler material with said MIG torch to form said full penetration weld.
